(19) United States
(12) Patent Application Publication
(10) Pub. No.: US 2016/0348551 A1
(43) Pub. Date: Dec. 1, 2016

(54) Universal zero carbon thermal electric clean engines with maximum absolute efficiency and power density, and supreme universal mobility

(71) Applicant: Marius Angelo Paul, Yorba Linda, CA (US)

(72) Inventor: Marius Angelo Paul, Yorba Linda, CA (US)

(21) Appl. No.: 14/545,829

(22) Filed: May 30, 2015

(51) Int. Cl. F01N 3/02; F02B 77/14; F02B 41/00

(52) U.S. Cl. CPC F01N 3/0205; F02B 41/00; F02B 77/14

(57) ABSTRACT

This universal technology eternal zero carbon, thermal electric clean engines and gas turbines, with universal cryogenic eternal systems converting all gases in cryogenic working fluids, for solar/atmospheric and geo thermal energy eternal systems, is eliminating 100% all the fossil fuels from energy and universal mobility, variable power, with constant maximum compression pressure and constant maximum combustion pressure, resulting constant maximum efficiency in all the variable eternal power electric generation and universal mobility systems.

The Universal Zero Carbon Thermal Electric Clean Engines, is eliminating for eternity the energy dependence from fossil fuels of any kind and sources, with zero emission producing energy, pure water, and rain, any time from request, to any place in the world.

This revolutionary eternal technology is the base for eternal prosperity off entire mankind.

With maximum absolute efficiency aero electric systems, by and power density is creating the technology for direct transformation of all and any thermal energies, from any sources, eternal, natural, renewable, wind, solar, geo thermal, nuclear, in clean energy, at lowest to zero carbon emission, universal pure water cogeneration, CNG, LNG, LH2, LPG Ethanol, BYO Fuels, NH3, with ultra low to zero emission systems, with <<<cross hybrid thermal aero electric systems>>>, by direct conversion of solar and atmospheric infinite thermal energy, lowest to zero carbon fossil fuels, in electric energy, unlimited driving, and at homes and urban electric eternal energy production, day and night, and independent from any environment conditions.

Eternal clean energy production in any place on this planet, including in deserts over the mountains, sea, from wind towers, sun, and atmospheric eternal and infinite thermal energy, nuclear, convertible directly in electric energy, pure water and rain.

Total recovery of the braking energy in stored high pressure compressed air, is eliminating ultra expensive and dangerous lithium -ion electric batteries, with revolutionary level of equivalent 200-300 miles per gallons, if is using any kind of fuels, including the capacity to the integrated mobile power plants for distributed power systems, independent electric energy of urban and human localities of any size, including homes, on land sea, and air universal aviation, without airports for universal eternal prosperity of the world and protection of the civilization of humanity.

This invention is a continuation in part of our original inventions with the title 1. “Universal Cross hyperbaric, hybrid, thermal electric engine compressor, expander and universal mobility systems.
application Ser. No. 13/815,071
Filling Date: Mar. 18, 2013
Confirmation NO: 2056/of Jul. 9, 2013

1 “Total synergetic integration of all eternal energies solar, atmospheric, wind, geo thermal, and universal fuel capability with maximum efficiency systems”.
application Ser. No. 13/986,989
Filling DATE Jun. 21, 2013
Confirmation NO. 5738/Jul. 30, 2013

3 “Universal thermal electric clean engines with maximum absolute efficiency and power density, and supreme universal mobility”.
application Ser. No. 61/997,030
FILLING DATE May 20, 2014
CONFIRMATION NO. 1182/ Jun. 11, 2014.

### BACKGROUND

The actual world crisis of energy and water, petrol, environmental pollution, combined with transportation systems characterized by low and extreme low efficiency, to use, to produce and protect the humanity, is a general punishment of the entire world.

The effective and most dramatic, evident, and terrible effect is the example of low efficiency of majority of multi million vehicles at the level of 15-20% efficiency, destroying 80-85% of energy of any fossil fuels, natural gas and petroleum fuels, lost by low thermal efficiency, cooling, exhaust gases and high mechanical frictions, and complexity of multi billion, trillion annual waste, including high emission of entire planet.

Entire planet is in total energy dependency from actual fossil fuels with carbon base composition.

The recent trial of unsuccessful lithium -ion batteries, for electric cars, is totally compromised by terrible cost, and aviation and electric vehicles explosions and self combustion, and total inexistent infra structure for charging batteries on similar time like filling a tank of liquid fuels, is limiting an illusory and totally false realistic potential future.

The potential use of renewable fuels in special CNG, LNG, LH2, is also punished by low efficiency of actual vehicles, of any size.

Our Universal Zero Carbon, Thermal Electric Clean Engines with maximum absolute efficiency and power density is the UNIQUE realistic revolutionary eternal solution for entire humanity and prosperity.

The low power density of actual existing conventional thermal engines, is producing the necessity for having big and complex engines with multi cylinders of four strokes, with restricted capability to use specific fuels like gasoline, diesel fuels, natural gas, alcohols, by octane and cetane numbers, specific for each type of fuels.

The spark ignited engine for gasoline engines are PUNISHED by strong barriers for raising the compression ratio, resulting extreme low efficiency.

The diesel engines are restricted also by high mechanical stress at high pressures, and by high pollution of NOX and poison of high smoke exhaust.

The natural gas limited use in transportation is limited by undeveloped infra structure with very low number of compressing CNG, LNG supplying stations, by NOX emission, and low efficient engines, is an other punishment of the world.

### BRIEF DESCRIPTION OF THE INVENTION

The Universal Zero Carbon, Thermal Electric Clean Engines with Maximum Absolute Efficiency and Power Density, is the culmination of the evolution of thermodynamic science, result of 30 years military secret research and development, recently open to the world of energy, universal mobility, pure water cogeneration, reached maximum absolute efficiency of combined aero solar thermal and geothermal individual or combined of integrated eternal energy systems of Paul-Yunkers cryogenic cycles, Carnot cycle, Rankin cycle, reaching totally over 80-90%, efficiency, and immense unique power density for direct transformation of all and any thermal energies in electric energy, with combined or universal fuel combustion of any and all fuels, natural, renewable, synthetic, CNG, LNG, LH2, LPG, ethanol, bio fuels, nuclear, geo thermal, solar energy, wind energy, atmospheric energy, sea water desalination, for hydrogen and oxygen energy production, virtually at lowest near to zero emission, including NOX elimination and zero Particulate matter. The new universal zero carbon, thermal electric clean engines, are offering universal applicability in all the energy generation, including distributed power systems, produce in individual homes, urban of any size, universal mobility systems for land, sea, and air universal aviation.

The original cross hyperbaric engine systems, described in our MULTIPLE original patented technology is now up graded to maximum absolute level of thermodynamic science of this invention, to the end of evolution, a real eternal revolution.

The new last resulted technology off this invention, is generating aero thermal individual and or combined geo thermal electric engines, with only 1, piston in 1 cylinder with the capacity to produce the conventional engines power of 16 cylinders.

The new thermal engine, with 2 pistons in 2 cylinders, with the capacity to produce the conventional engine power of 32 cylinders.

The new engines with 3 cylinders having 4 pistons, to produce the power of 64 cylinders of conventional engines with 64 cylinders with 64 pistons.

The combined cryogenic liquid air, LNG, L/hydrogen, L/oxygen cycles is by maximizing the capacity of engine, to receive of all and any external energies from sun, wind, atmospheric, and geo thermal infinite and eternal energies.

All of them with maximum absolute efficiency over 80-90% efficiency, is conquering the sea, near zero emission, and universal fuel capability, resulting the end of era of engines with more than 4 pistons and more 4 cylinders.

The immediate result is the capability to replace all existing conventional engines, driving cars with 15% efficiency, using only petrol derivative fuels consuming in USA $400 billion, per years from which 85%, $360 billion are totally lost thermal energy, and giant emission, a real war of bad efficiency against the American nation, and all the world.

This unique zero carbon, and eternal technology is conquering the land, sea and universal aviation without airports, capable to reach universal connection of entire worlds with the capability of renewable fuels, from wind, solar, hydrogen, geo thermal, and alternative, to use nuclear energy for unlimited eternal life and power.

The biggest new maximum performance of power density, is solving the general limited intake and exhaust capability of all conventional engines, in special for two stroke engines, in which the size and configuration of intake and exhaust ports, must be associated with limited area around the periphery of the cylinder bore.

The conventional four stroke engine must divide the area of intake valves, and exhaust valves in a near 30% of the area of the cylinder bore with similar limited capacity for air/exhaust resulted lower power density, and smaller torque.

The conventional opposed piston engines, are provided limited one area off intake/exhaust ports with similar limited capacity for air/exhaust conventional opposed piston engines are provided with limited area of intake ports, and a one opposed area ports for exhaust.

This limitation of air/exhaust capacity is the stronger blockage of performances of all two and four stroke engines.

Our new Universal Zero Carbon Thermal Clean engines is maximizing the air intake/exhaust capacity with double intake and double exhaust, creating the maximum absolute performance capability first time in the history of all internal combustion engines

This double area for intake and exhaust is raising the expansion stroke by the reduced heights, of exhaust ports with direct maximization of power expansion strokes and maximum efficiency, reflected in lower exhaust temperature, and maximum higher efficiency.

The new generation of universal cryogenic counter rotating multiple stages compressor, integrated and associated with symmetric counter rotating multiple stages of turbine rotors, is producing the biggest power density and maximum compactness and absolute efficiency for gas turbines, and the base for cryogenic liquefaction of all gases, including liquid air for maximization of heat transfer for recovery of all aero, solar, geo thermal nuclear, and any external sources of thermal energies.

### BRIEF DESCRIPTION OF PREFERRED EMBODIMENT OF THE INVENTION

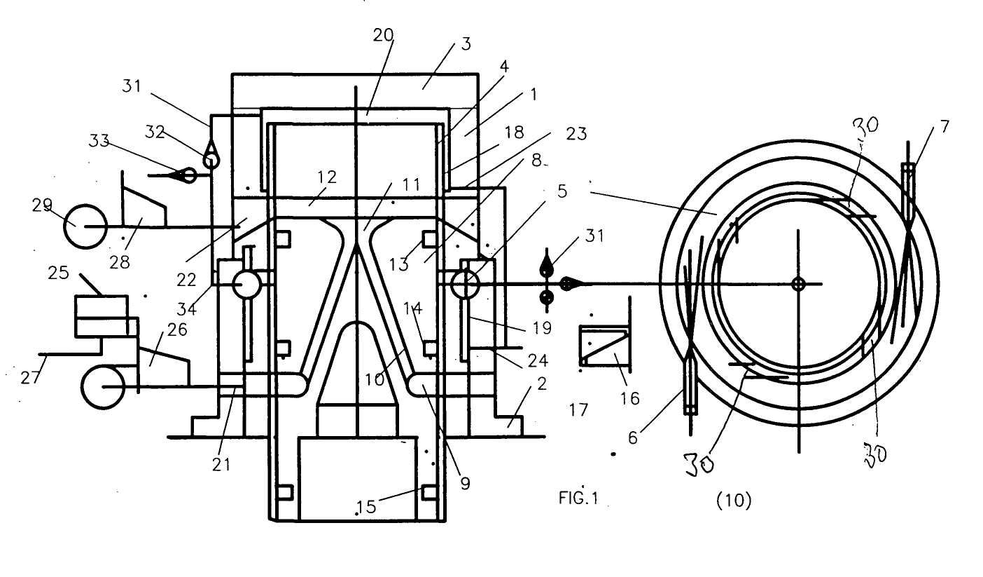

In the FIG. 1 is depicted the Universal Zero Carbon One Cylinder Clean Engine with double intake and exhaust area.

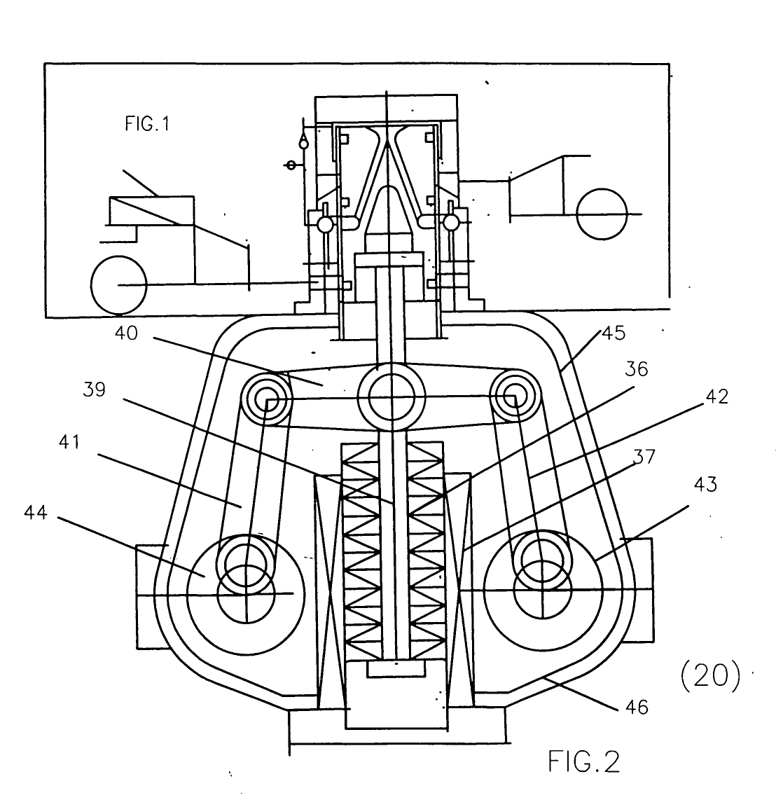

In the FIG. 2, is depicted the one cylinder thermal electric engine.

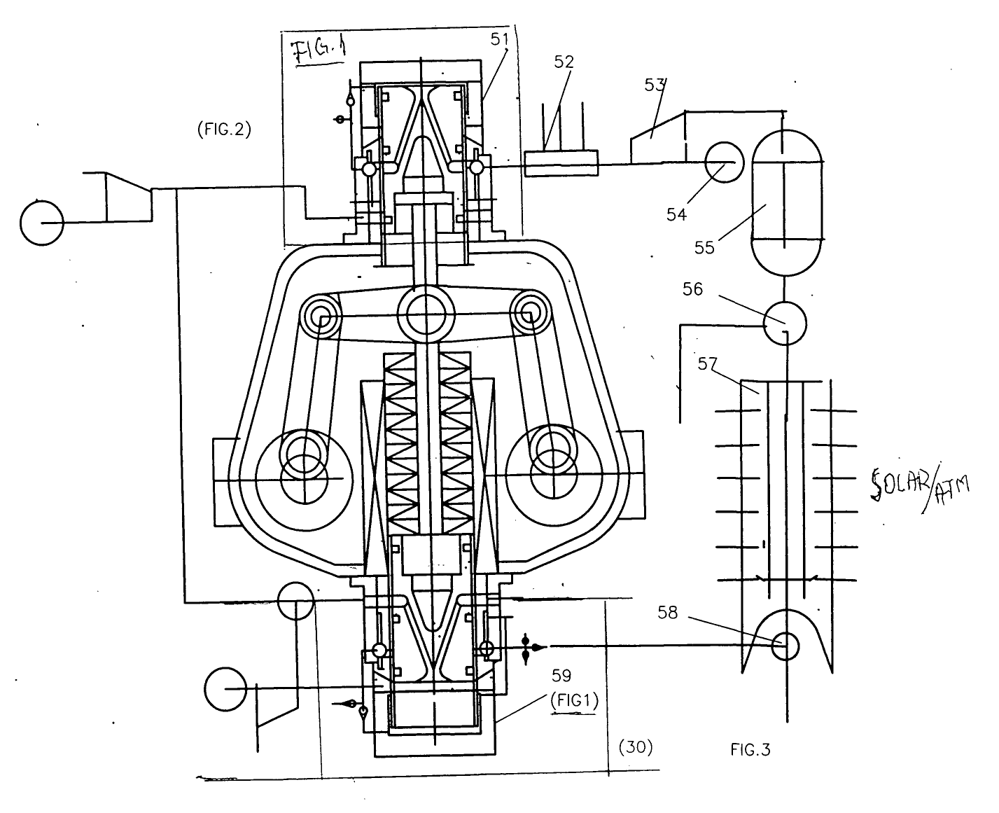

In the FIG. 3, is depicted the two symmetric cylinders thermal electric engines with double universal combustion chambers, with eternal cryogenic aero thermal solar energy systems.

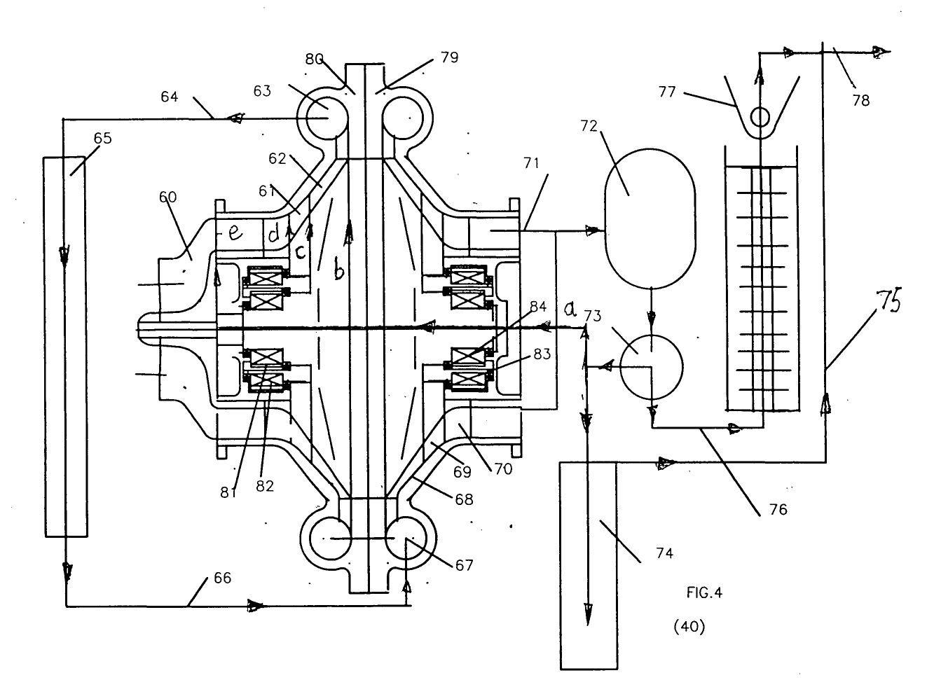

In the FIG. 4, is depicted the cryogenic universal compressor-expander, with the capacity to liquefy any gases, including air, hydrogen, oxygen, CO2, LNG, for eternal aero thermal electric and geo thermal energy recovery.

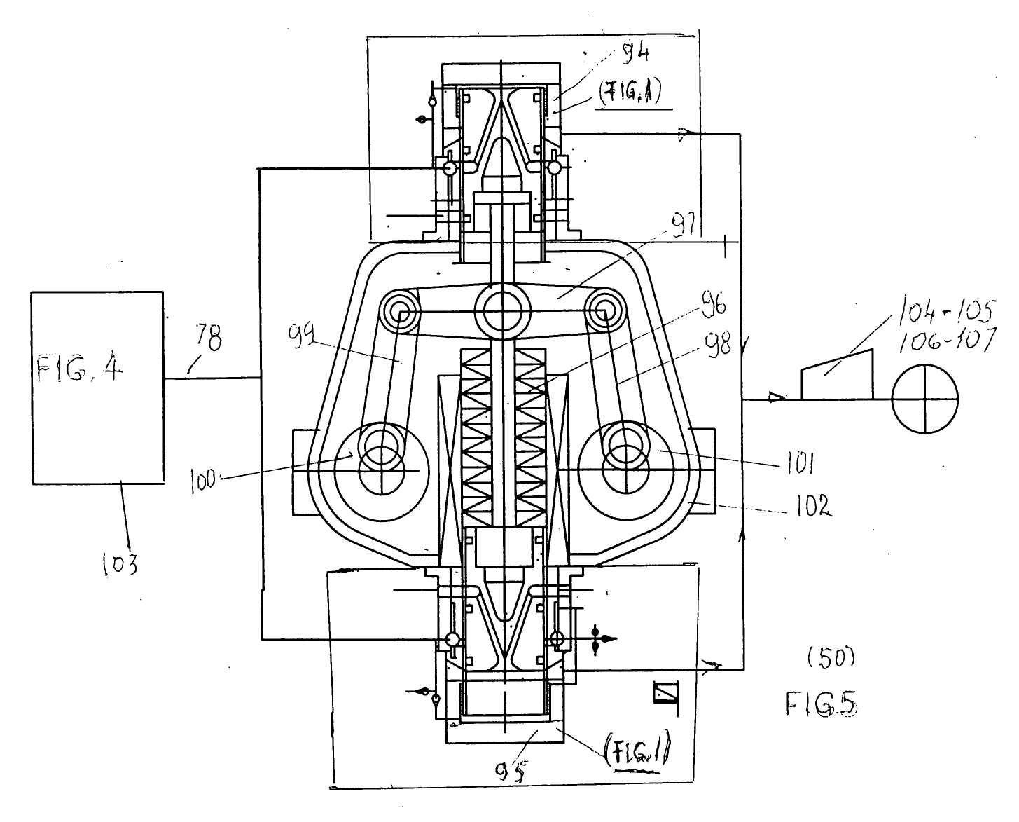

In the FIG. 5, is depicted the eternal cryogenic double air and geothermic total thermal electric engine, with two opposed symmetric cylinders, with top absolute power density, and maximum efficiency.

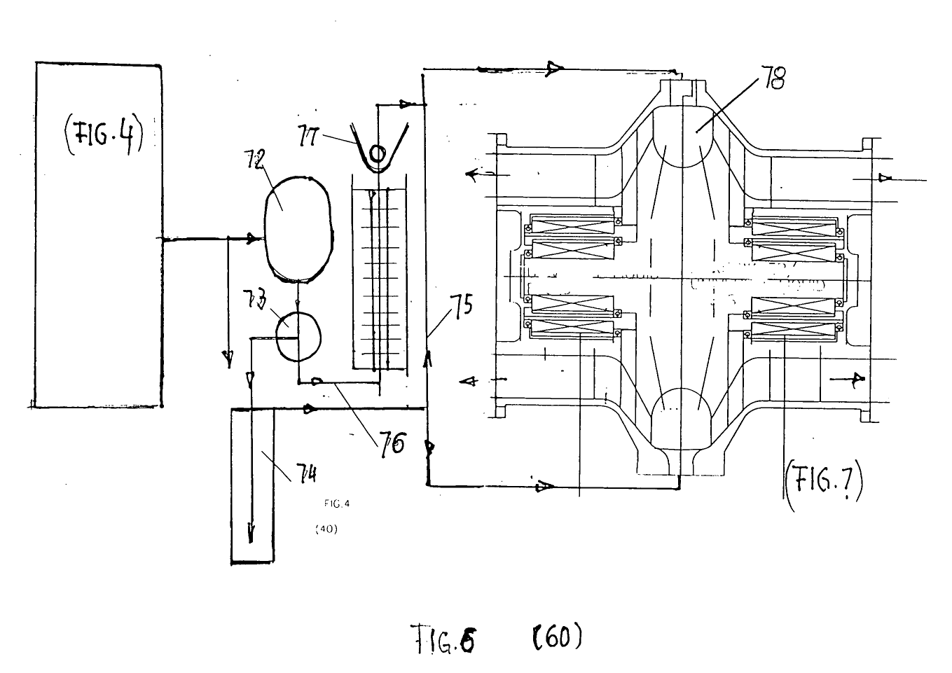

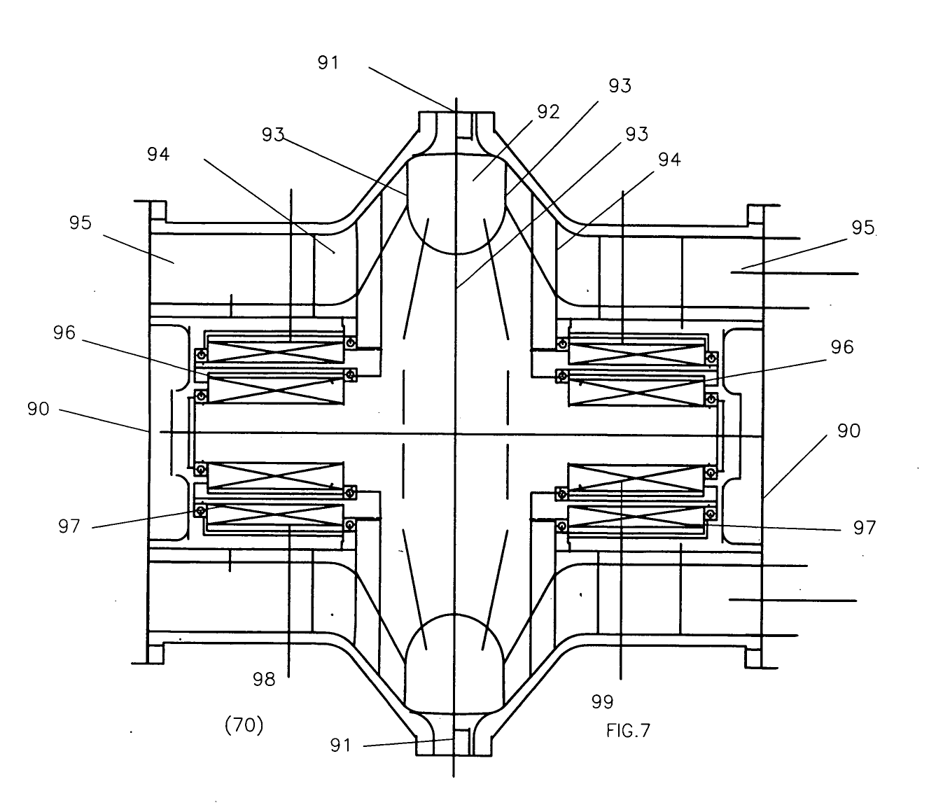

In FIG. 6 is depicted the eternal universal cryogenic thermal aero thermal electric. and geo thermal energy recovery by turbo compound of symmetric compressor and expander, for aero electric and geo thermic and nuclear universal energy with combined integrated technology of FIG. 4 and FIG. 7 systems.

In the FIG. 7 is depicted the Universal Turbo Electric Expander, of any and thermal and eternal sources of energies.

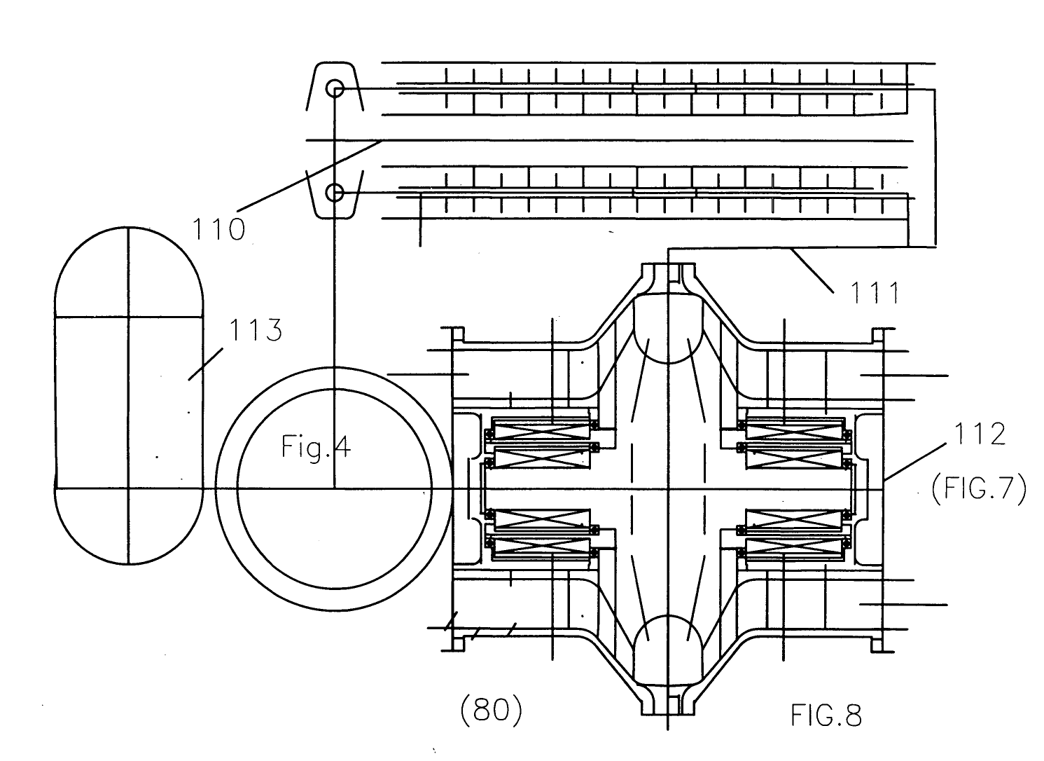

In the FIG. 8 is depicted the Universal Aero solar thermal energy system, combined integration of technology, for all universal land, and sea vehicles described and resulted from participation of technologies of the FIG. 4 and FIG. 7.

In the FIG. 1, is depicted the Universal One Cylinder Engine with composed cylinders indicated by the generic number (10), with double intake, and double exhaust area composed from cylinder 1, and 2, covered by top cylinder 3, cylinder liner 4, including a toroidal combustion chamber 5, provided with tangential fuel injector 6, and 7, piston 8 provided with a toroidal connection 9, and connection channels 10, and top opening combustion ports 11, with exhaust ports 12.

The piston 8 is provided with piston rings 13,14,15,16,17.

The cylinder liner 4, is associated with cooling chambers 18 and 19, connected with the toroidal chamber 5 and top combustion chamber 20.

The intake circular channel 21, and the exhaust circular channel 22, is the maximum area for air intake/exhaust system possible capacity for maximum performance of power and efficiency.

The recovery chambers 18, and 19. are filled by compressed air, at the end of compression, is creating a thermal barrier for thermal lost by absorbing the cooling of the liner 4, and at the top of compression and starting combustion, pure water is injected, by the injectors 23, and 24, producing an instant evaporation and steam internal cogeneration, absorbing the heat transferred by the liner 4.

The steam internal cogeneration cooling is pushing back the compressed air cycle and steam cogeneration for recovery all the cooling energy, a real adiabatic engine, with <<<triple thermal cycles>>>, with total synergetic universal cycle with near 100% thermal efficiency.

The electric supercharging with 25, 26 air/oxygen 26 is eliminating the nitrogen 27, resulting supplying of pure oxygen in the cylinder channel 21, creating 5 time more energy capacity for combustion with absence of NOX, and minimum to zero emission, resulting pure water condensation, and maximum absolute power density and maximum absolute efficiency near 100%.

The exhaust gases and steam exit from cylinder steam exit from circular channel 22 are expanded in the exhaust turbine 28 driving the electric generator 20, resulting a turbo electric turbo compounding system with maximum efficiency.

When the piston 8 is moved in the top dead center at the end of compression stroke, the circular toroidal channel 9, is connecting the combustion chamber 5, producing the injection of compressed air by tangential ports 30 in the toroidal chamber 5, which is creating an intensive mixing of the tangential fuel injected by injectors 6, and 7, and reversal flow through channels 10 in the combustion chamber 20 from chamber 5 to the top chamber 20.

By expansion stroke moving down the piston 8, the connection of the toroidal chamber 5, is separated from the combustion chamber 20, resulting a retention of partial expanded combustion gases which, will form a residual plasma, for receiving the self compressed air fuel injection, by the pressure channel 31, controlled by the valve 32, fuel uniflow valve 33 and fuel self injector 34 in the toroidal universal combustion chamber 5, supporting continuous partial combustion until the next injection of compressed air by the next power cycle.

The existence a permanent plasma of hot combustion gases, will produce the ignition and continuous combustion of any and all fuels, with disregard of any octane or cetane number at any regime of power and rotation, creating a unique universal fuel engine, at any compression ratio of air separated from injected fuels until the injection of compressed air in the universal toroidal combustion chamber 5.

The diverter three valves and channels 31, can make alternative communications, with any gaseous fuels of CNG, LNG, LH2, steam from all external sources of energy, like nuclear reactors, aero/solar thermal energy, and/or geo thermal steam, resulting an universal eternal Zero Carbon Thermal Electric Clean Engine.

This is basic cylinder engine can create the fundamental universal maximum power density and maximum absolute efficiency for all eternal applications, and all potential engines configurations.

The fundamental conclusion of the Universal Zero Carbon Thermal Electric Clean Engines, provided with total intake and total exhaust, is produced by the Uniflow Cross Piston Scavenging System between the toroidal intake on the bottom of the piston 9/cylinder 21 and the toroidal exhaust ports 12 in the cylinder, eliminating the very poor conventional loop scavenging, by the limited exhaust and intake ports at the bottom dead center of the piston in cylinder.

The universal reversible self convertibility at request of the engine in compressor-expanders for any gases, in special for CNG, air, hydrogen, CO2, is solving the biggest problem of limited stationary CNG national incapability to generalize the CNG in large land transportation, and general hybrid bracking energy recovery, by compressed air and expander electric operation.

By this invention universal unique convertibility, all the new engine, compressor, expander, will open a universal penetration of CNG in the national universal mobility systems with trillion national salvation, replacing the terroristic world domination of opec, and unfriendly petroleum companies.

The fundamental conclusion of the technology described in the FIG. 1, is creating the basic and essential universal energy system forming the substance and spirit of this invention in all universal potential configuration, of one, two, three, four opposed and symmetric pistons and cylinders, operation and application, for eternal energy—water and life for entire world.

In the FIG. 2, is depicted The Universal Zero Carbon Thermal Electric Clean Engine, with one cylinder, indicated generically by the number (20), composed and described in detail (squear) from the earlier FIG. 1, with additional package 36 of permanent LINEAR magnets, surrounded and sliding without contact and friction, Inside the stator coil bobbin 37, centered by the axial rod 39, connected by the cross bar 40, with symmetric connecting rods 41, and 42, driving the symmetric counter rotating crankshafts 43, and 44, included in the top cover 45 and bottom cover 46, forming the body structure of the thermal electric hyperbaric engine,

The essential component of this engine is the unique thermal electric piston 8 of the FIG. 1, associated with the linear electric generator 36, 37, and 39, directly converting all thermal energy inn electric energy, supplying alternative current (AC), to the grid or universal users. The integrated assemble cross mechanism 40, 41, 42, 43, and 44 is producing a total elimination of any and all side forces <<<a real flying pistons>>> which in conventional engines is forcing the contact and friction of the pistons with cylinders, creating also an absolute total balancing of all inertial forces and momentums.

The universal thermal electric clean engine is supplying ONLY electric power to any users of energy and for universal mobility vehicles on land, sea, and aviation. This unique Universal Zero Carbon Thermal Electric Clean Engine is the top absolute revolutionary maxim power density and maxim absolute efficiency in the history of humanity.

The Universal Zero Carbon Eternal Thermal Electric Clean Engine is capable to produce the power of equivalent 16 cylinders of conventional four stroke engines with similar size of cylinders.

The maximum efficiency of 80-90% of our engines is compared with 15-30% of existing conventional engines, resulting a total eternal revolution of this new patent application.

In the FIG. 3 is indicated by the generic number (30) the depicted Universal Zero Carbon Thermal electric clean engine, forming an assembly of symmetric two basic cylinders described in the FIG. 1, and followed by the engine described in the earlier FIG. 2. This Universal Zero Carbon The Electric Clean Engines is capable to produce the equivalent power of 32 cylinders, of similar cylinders conventional engines of four strokes, with maximum absolute power density, and maximum absolute efficiency of 80-90%, versus 15-30% of all conventional engines of four strokes.

One cylinder 51, of FIG. 2. In the FIG. 2, of the two cylinders, is capable to be converted to operate like a high pressure air compressor indicated by the number 51, supplying the hot compressed air in the air cooler 52 reducing the temperature of compressed air close to the ambient temperature, followed by the turbo electric expansion 53, driving the electric generator 54, producing the liquefaction of the air, at −320 F. stored in the thermal insulated (thermos like) 55, from which the liquid air is pumped by the hydraulic pump 56, and conducted in the aero-thermal solar parabolic heat exchanger 57 capable to over heat and gasification the liquid air and to raise the temperature of the compressed air at multiple time over the liquid air (boiling) temperature.

The process of over heating the compressed air in the parabolic heat exchanger 57, can reach over 600-1000 C. symilar a rocket energy jet conducted in the opposed cylinder 59.

The next step of this hot compressed air, will activate the symmetric opposed cylinder 59, of FIG. 1, producing energy exclusively including from eternal atmospheric thermal energy, received from sun, and atmospheric infinite stored thermal energy, including in the night, permanent energy generation, with zero additional carbon fuel, of any kind, for eternity,

In FIG. 4 is indicated by the generic number (40), the depicted technology of cryogenic electric compressor-expander, with the capacity to turbo compress, turbo expansion and liquefaction of any gases, including multiple compressor stages, and multiple air, hydrogen, CO2, CNG, LNG, for aero electric and geo thermic energy recovery, composed from symmetric counter rotating multiple electric independent driven compressor stages, and multiple turbine expander stages.

Basic pressure ratio for compression and expansion for liquefying air is P1/P2=116−120, divided three stages of 4×5×6, with assisted liquid air recirculation between inter stages by controlled (%) of injected liquid air to create a politropic compression close to izothemic exponent N=1−1,2.

The assembled unique two symmetric turbo machinery, in one integrated unit, in which is creating double symmetric opposed cycles <<<turbo compressor-turbo expander>>> is creating the biggest thermal power concentration and density ever in the history of thermodynamic and energy, to be the base of most powerful engines and gas turbines in the world for eternity.

The perfect balanced of compression work, by equal and expansion work is the fundamental reason off maximum absolute efficiency, and minimum thermodynamic and mechanical loses.

All the compressor and expander stages, are axial balanced, zero friction, with zero physical friction and contact by gaso dynamic lubrication, zero radial bearing loads, virtually zero friction by gaso dynamic bearing lubrication, virtually <<<flying compressor and turbine rotors>>>.

The compressor stages are composed by first centrifugal rotor disc 60, followed by the counter rotating axial-centrifugal second stage rotor 61,

and 62, discharging the compressed gas in the collector 63 conducting the compressed gas by the channel 64, in the gas cooler 65, from which the channel 66, is conducting the cooled compressed gas, in the toroidal collector of the turbine 67, followed by the turbo expander counter rotating stages, 68, 69, 70, producing a total expansion until status of liquefaction AT −320 F.

The liquefied gas is conducted by channel 71, in the reservoir thermos 72, and is pumped by the hydraulic pump 73, to three direction, first to geo thermal underground heat exchanger 74, and the second direction 76, to the aero—solar-atmospheric, parabolic heater 77, the third direction is conducting a portion of liquid (a-b-c-d) air between 4×5×6 compressor pressure stages, to create an inter stages cooling and producing the real polytropic-isothermic final compression from which the heated compressed gas is supplied to the user 78.

The result is the biggest and unique eternal collector of sources of energy for power generation in the history of mankind with eternal Zero Carbon belectric power generation.

one other of the most important result can be the liquid air for dispersing in the clouds for rain generation and life prosperity over the world.

this technology of eternal collector and integration of all eternal thermal energies. Is the base for the biggest miracle energy revolution in the history of mankind.

In the FIG. 5, indicated by the generic number (50), is depicted the general assembly of the Universal Zero Carbon thermal electric cryogenic double air and geo thermal electric engine, with two symmetric cylinders, described in the basic FIG. 1 with top absolute power density and maximum absolute efficiency of the assembly, with two opposed symmetric expander cylinders 94 and 95, described in the earlier, FIG. 3, with additional symmetric thermal electric linear generators 96 forming thermal electric power generator assembled by cross bar 97, driving by two symmetric counter rotating crankshafts 100 and 101, included in a general assemble carcass 102.

The cylinders 94 and 95, is receiving the high pressure hot aero and geo thermal air supplied by the compressor-expander of FIG. 4 resulted from liquid air stored in the thermos receiver 72 from witch the hydraulic high pressure pump 73, is injecting the liquid air in the geo thermal heat exchanger 74, in which by big temperature radiated by geo thermal infinite energy, the liquid air is gasified, and transformed in high pressure, high temperature working fluid, associated with the additional aero solar thermal energy, from the parabolic solar heat exchanger collector 76 and 77, to be supplied in both cylinders 94 and 95, of FIG. 1, producing Zero Carbon eternak electric energy, with additional turbo electric expanders 104, 105, 106,107.

These two eternal associated energy working fluids is equivalent, with two rocket jets conducted en the hyperbaric thermal electric engines, producing immense eternal clean electric universal power. an additional capability is for supplying liquid air 103 for dispersing in clouds for rain any tyme, any were, for eternal mankind prosperity,

Alternatively, if is available liquid hydrogen, result of wind and solar-air, waterelectrolizer, the geo thermal, hot air can start a supplementary energy generation from combustion of hydrogen total eternal maximum a solute power and pure water generation for eternal prosperity of mankind.

This Supreme Zero Carbon universal thermal electric clean engine, is the absolute culmination of thermodynamic science and energy systems for eternity.

In the FIG. 6 is indicated by the generic number (60) The Universal Zero Carbon Thermal Clean turbo energy system, integrated with a, universal compressor expander from FIG. 4, composed from the turbo expander 78 described in the FIG. 7, supplying the liquid air flow 76, which is conducting high pressure liquid air in the parabolic solar/atmospheric thermal energy collector 77, which is generating hot high pressure air, conducted, in parallel with the hot pressure geo thermal air from heat exchange 74 to 75 collector infinit eternal thermal energy from deep tera ground thermal energy, for eternal production, in any and all the places of this planet, including the most isolated and abandoned places in this world, arrid deserts, jungles, mountains, million islands, generating rains for eternal fertilization, without any sources of energy and water, for guarantee the eternal life of entire world.

In the FIG. 7, is depicted the eternal cross double symmetric gas turbine expander, indicated by the generic number (70), composed from a central symmetric assembled universal turbomachinery 90, receiving any working energy fluids, from any and all energy thermal sources in the peripheral entrance port 91, supplying the working fluid in the toroidal chamber 92, from which the working fluid is symmetrically expanded continuous, and will expanded through the first stage turbines blades 93, and will expanded continuous in the symmetric counter rotating turbines rotors 94, and evacuated in a final expansion by the exhaust nozzles 95.

The power produced by the central symmetric turbine 93, is producing electric energy by the symmetric rotary concentric generator 96, and the power produced by the counter rotating symmetric turbines 94 is producing electric energy by the symmetric concentric electric generator 97.

The electric energy produced by the symmetric counter rotating concentric electric generators are supplied outside by the exit conduit 98 and 99.

The universal working fluids, can be any combusted gases, can be steam from any sources, including nuclear, can be compressed air, and compressed natural gases, combusted in the toroidal chamber 92, or can be the eternal aero solar and geo thermal hot and super high pressure air supplied by the universal compressor expander of FIG. 4, producing liquid air, which collected eternal zero carbon zero emission, energy of solar-atmospheric and geo thermal, total associated eternal energies.

In the FIG. 8, is indicated by the generic number (80), the unlimited source of aero solar and geo thermal energy, for general eternal zero carbon applications on all land and sea vehicles, for propulsion, electric power-water generation, to cover all the planet transportation, including refrigeration. the sea vessels, navigating all oceans, transporting all, goods, and liquid gases, petrols, liquid hydrogen, and supplying directly electric energy to any land distribution ports, generating instantly rains, in any places in the world, including the most isolated huge deserts, abandoned islands, jungles, can be an universal guaranteed world economic miracle and energy power, water, and prosperity instantly from contacting the entire world.

All the vehicles can be covered by panels of parabolic multiple solar-atmospheric energy collectors 110, forming serial or parallel thermal aero energy collectors, receiving high pressure liquid air, or any gases, from the universal compressor-expander of FIG. 4, over heated and transformed in hot pressure working fluid 111, which will be expanded in the universal turbo expander 112, described in the FIG. 7, and universal thermal electric engine expander described in the FIG. 5, is producing the electric energy for hybrid propulsion and all energy applications.

Alternatively the hot high pressure air can be stored in large thermoses receivers 113, for saving and storing energy available any time days and nights.

Always the available liquid air can be dispersed in the clouds, of port locations, and over the land producing rains, fertilizer of any place making the land a garden of paradise, and support eternal life of humanity, real gift from god.

What is claimed:

1. This is the general technology for creating an universal energy system for integrating in a synergetic system of zero carbon operation the universal hyperbaric internal combustion thermal electric engine, with a self generation, and operation a cryogenic generator of all liquid gases, like liquid air, liquid oxygen, liquid hydrogen, liquid natural gas, co2, to be reheated, absorbing and collecting eternal infinite solar/atmospheric energy, in parabolic energy thermal generator day and nights, geo thermal energy, wind, including thermal energy from a nuclear reactor to cooperate for final electric energy producing and water cogeneration using the same working crayogenic system, for recovering all cooling and exhaust engine waste, and liquid status resulting an unified harmonic energy system, working at constant maximum compression ratio, and constant maximum combustion pressure, resulting constant absolute maximum efficiency, capable to operate and producing variable electric energy and cogenerate energy and pure water, with zero carbon, replacing 100% fossil fuels, on any place over this planet, at zero emission, and to the end of the existing world, and creating the universal base for all systems of eternal energy production and distribution, by stationary variable production power plants systems and universal mobility systems on land, sea, and air, capable to operate at constant maxim pressure compressing and combustion systems, at all regimes of variable power, and speed, from full maximum power, to minimum practical power, conserving constant maximum absolute efficiency, for variable energy generation, and variable universal mobility.

2. The zero carbon universal hyperbaric thermal electric engine from the claim one, is created from a group of basic ONLY, ONE, TWO, or Three cylinders, forming unlimited symmetric general configuration, of opposed cylinders, and opposed symmetric pistons engines in one common cylinder, provided with universal thermal electric pistons, assembled with linear electric permanent magnetic AC generators, associated in symmetric opposition by the cross bar mechanism, driving symmetric counter rotating two rotary crankshafts mechanisms, which is balancing and eliminating all the side forces, between pistons and cylinder walls created by the two symmetric connecting roads articulated with the cross bar and crankshafts, driving electric symmetric counter rotating rotary generators, resulting virtually zero forced friction between pistons and cylinder walls, and zero inertial forces and momentums, resulting the delivery of the variable power, completely only by electric energy, and pure water, at all regimes of variable power and rotation, with constant maximum compression ratios, constant and maximum combustion constant pressure, resulting maxim absolute efficiency from full variable maximum power and rotations, to the minimum power and rotations.

3. The universal hyperbaric thermal electric engine cylinders, from claim one and two, is provided with circular toroidal universal combustion chamber, located inside of cylinder walls, between two circular ports for intake and exhaust, working in correspondence, with the circular toroidal piston channel, controlling the intake, exhaust, and universal combustion phases, in correspondence with the system for internal steam cogeneration by injecting high pressure pure controlled water in the thermal barrier concentric cooling jacket for internal cogeneration and total recovery of thermal energy, from the cooling process of cylinders, and exhaust energy, creating a universal triple thermal cycle engine, real adiabatic with recovery all cooling waist energy, creating a multiple optional operation capability provided with direct injection, self injection of any liquid fuels for alternative optional operation, in parallel with cryogenic green eternal zero carbon, universal internal combustion engine, compressor, and expander power, of the working eternal solar/atmospheric, geo thermal fluid, generated by the cryogenic energy cycle, alternative compressor operation for air hybrid system recovering all of the braking energy, and expander power operation, of the synergetic eternal zero carbon universal cryogenic variable operating process, Including supplying requested rain, by dispersing liquid cryogenic gases in clouds in any place in which the water rain is a life condition for ever.

4. This integral production green zero carbon eternal synergetic energetic system from claim one, is a multi functional generation operating energetic systems, for all universal mobility systems for general land transportation cars, trucks, urban transportation, locomotives, forming mobile general distributed variable power plants, general naval power propulsion plants, forming distributed variable electric and water sources of supplying cryogenic fuels like liquid hydrogen, liquid oxygen, LNG, CNG, in all the world resulted from eternal solar, atmospheric, geo thermal, wind, nuclear, including electrolysis sea or any available water, for hydrogen and oxygen eternal infinite zero carbon generation in all the places on this planet, for unlimited desalinated water available in any and all places in the world, including rain production by clouds condensation from dispersing cryogenic liquid gases, by aviation.

5. All the universal eternal energetic synergetic operations systems, from claim one, produced by individual or combined the universal hyperbaric thermal electric engine, are also accomplished individual or combined by the hyperbaric universal turbines systems, associated with the cryogenic electric compressor and expander liquid gases generator, for generating thermal variable power from eternal solar energy parabolic generators, wind and geo thermal eternal cryogenic general generators, supplying infinite and eternal electric variable power and water, depending the size, environment, and optional operation on constant maximum compression ratios, constant maximum combustion pressure, resulting constant maximum absolute efficiency, from full maximum power to lowest practical power on land, sea, and geographic specific conditions.

6. All this universal eternal technology is based on zero carbon thermal electric synergetic hyperbaric engines and turbines, from claims 1, and 5, which is forming integrated universal eternal energetic systems, including and based on universal electric compressor with multiple controlled independent stages, producing variable, quantities of compressed gases, at constant maximum pressure, associated with multiple electric stages symmetric expander turbine, and an integrated cooling systems, internal [symbol]
